(19) United States
(12) Patent Application Publication
(10) Pub. No.: US 2007/0064783 A1
(43) Pub. Date: Mar. 22, 2007

(54) Transmission/reception apparatus and transmission/reception method for enabling coexistence of systems

(76) Inventors: Go Kuroda, Osaka (JP); Akio Kurobe, Osaka (JP); Koji Ikeda, Osaka (JP); Hisao Koga, Fukuoka (JP); Yuji Igata, Fukuoka (JP); Hirotoshi Yamada, Tokyo (JP); Yoshinori Mizugai, Tokyo (JP); Hiromu Okamoto, Tokyo (JP); Junichi Ohshima, Tokyo (JP); Shigeru Takasu, Tokyo (JP); Takehiro Sugita, Tokyo (JP)

Correspondence Address: WENDEROTH, LIND & PONACK L.L.P., 2033 K. STREET, NW, SUITE 800, WASHINGTON, DC, 20006, US

(21) Appl. No.: 11/480,364

(22) Filed: Jul. 5, 2006

(30) Foreign Application Priority Data
Jul. 5, 2005 (JP) 2005-196366

(51) Int. Cl. H04L 5/16

(52) U.S. Cl. 375/222

(57) ABSTRACT

An in-home-system master station of an in-home communication system detects a frequency band (a channel number corresponding to a data communication subchannel) or a time slot used by each station of an access communication system, using a coexistence signal subchannel. Based on the detected information, the in-home-system master station determines a frequency band or a time slot to be used in the in-home communication system to which the in-home-system master station belongs, so as not to avoid overlapping the frequency or time slot used in the access communication system, and informs each in-home-system slave station of the determined frequency band or time slot.

### BACKGROUND OF THE INVENTION

1. Field of the Invention

The present invention relates to a transmission/reception apparatus and a transmission/reception method for enabling coexistence of systems. More particularly, the present invention relates to a technique of enabling coexistence of two communication systems which use the same communication medium and have different communication schemes, a transmission/reception apparatus included in each of the communication systems, and a method which is executed by the transmission/reception apparatus.

2. Description of the Background Art

Power line communication technology is a communication means for connection of a Personal Computer (PC) in a home to a network apparatus, such as a broadband router or the like, so as to access from the PC to the Internet. In the power line communication, since an existing power line is used as a communication medium, it is not necessary to perform a new wiring work, and high-speed communication can be achieved only by inserting a power supply plug into a power supply outlet available throughout a home. Therefore, research and development, and demonstration experiments of the power line communication technology have been vigorously conducted all over the world, and in Europe and the USA, a number of power line communication projects have already been commercialized.

An example of the power line communication is HomePlug Ver. 1.0, which is a specification created by the HomePlug Powerline Alliance (USA). The specification is intended to be used mainly in applications, such as the Internet, mailing, and file transfer which are performed by a PC. HomePlug employs a CSMA/CA technique for a medium access control of which power line communication modem accesses a power line, and provides best-effort communication which does not guarantee a band to be used.

FIG. 25 is a diagram illustrating a configuration of a general communication system when accessing to the Internet. In FIG. 25, a PC2501 is connected via an Ethernet 2511, a broadband router 2502, and an access line 2512 to the Internet 2522. As the access line 2512, ADSL, FTTH, or the like is generally used. Here, when a place where the access line 2512 is withdrawn into a home is different from a room where the PC 2501 is placed, the Ethernet 2511 needs to be extended. Therefore, a power line communication apparatus has been commercialized in the form of a conversion adaptor between power line communication and Ethernet.

FIG. 26 illustrates a configuration of a communication system employing a conversion adaptor. In FIG. 26, two power line communication-Ethernet conversion adaptors 2603 and 2604 are connected to power supply outlets in rooms where a PC 2601 and a broadband router 2602 are installed, respectively, and provide best-effort communication by using power line communication via an in-home power line 2614. Thus, by using power line communication, wiring work is not required, and high-speed communication can be achieved only by inserting a power supply plug into a power supply outlet available throughout a home.

In Europe (Spain, etc.), an access power line communication modem has been used which employs, as an access line to the Internet, a power line for supplying a power to a home. FIG. 27 is a diagram illustrating a situation where the access power line communication modem is used. An access power line communication modem master station 2703 provided at an outdoor transformer, is connected via an intermediate voltage power distribution line 2713 to a broadband line, and performs IP packet communication with an in-home access power line communication modem 2702 via a low voltage power distribution line 2712, a distribution switchboard 2715, and an in-home power line 2711. Further, by connecting the access power line communication modem 2702 with a PC 2701 via an Ethernet 2704, access to the Internet can be performed from the PC 2701.

Thus, by using the access power line communication modem, access to the Internet can be provided without withdrawing a cable or the like into a home. In addition, since the access power line communication modem 2702 is installed at any arbitrary outlet in a home, the degree of freedom of installing is higher than that of ADSL, FTTH, and the like.

FIG. 28 is a diagram illustrating an internal configuration of a general power line communication modem. In FIG. 28, the power line communication modem comprises an Analog Front End (AFE) 2801, a digital modulation section 2808, a communication control section 2809, and an Ethernet I/F section 2810. The AFE 2801 includes a Band-Pass Filter (BPF) 2802, an Automatic Gain Control (AGC) 2803, an A/D conversion section 2804, a Low-Pass Filter (LPF) 2805, a Power Amplifier (PA) 2806, and a D/A conversion section 2807. Hereinafter, an operation of the power line communication modem will be described.

Assuming that Ethernet packets are transmitted onto a power line, when an IP packet arrives from an Ethernet 2811, the communication control section 2809 is informed of the arrival via the Ethernet I/F section 2810. The communication control section 2809 determines a state of a communication channel, and outputs frame data to the digital modulation section 2808 with appropriate timing. The digital modulation section 2808 performs error correction addition, encoding, framing, and the like to modulate the frame data into a transmission data sequence. The D/A conversion section 2807 converts the transmission data sequence from a digital signal to an analog signal. The PA 2806 amplifies the analog signal. The LPF 2805 cuts off signals other than communication band components from the amplified analog signal, and inputs only the communication band components onto a power line. Next, in the case of reception from a power line, the BPF 2802 extracts a signal in a communication band. The AGC 2803 amplifies the extracted signal. The AID conversion section 2804 converts the amplified analog signal into digital data. The digital modulation section 2808 performs frame synchronization detection, equalization, decoding, error correction, and the like with respect to the digital data to demodulate the digital data and informs the communication control section 2809 of the resultant data as received data. Thereafter, the received data is transmitted as an Ethernet packet from the Ethernet I/F section 2810 to the Ethernet 2811.

On the other hand, there is IEEE802.11a, which is a representative standard for wireless LAN. In 802.11a, a band used therein is divided into a plurality of channels for IP communication. IEEE802.11h is added to IEEE802.11a so as to meet requirements in Europe when a 5-GHz band is used. See, for example, IEEE Std., 802.11h-2003: “Wireless LAN Medium Access Control (MAC) and Physical Layer (PHY) specifications, Amendment 5: Spectrum and Transmit Power Management Extensions in the 5 GHz band in Europe”. One of the functions specified in 802.11h is a Dynamic Frequency Selection (DFS) function of detecting a band which is used by a radar, such as a meteorological radar or the like, and automatically shifting to a channel which avoids the band to avoid interference. An exemplary DFS operation will be hereinafter described.

FIG. 29 is a diagram illustrating an exemplary configuration of a communication system which performs the DFS operation. The communication system of FIG. 29 is composed of an Access Point (AP) 2901 in 802.11a, Stations (STAs) 2902 and 2903 in IEEE802.11a, and a meteorological radar 2910.

The AP 2901 transmits a command to stop communication using a beacon frame in predetermined time intervals to the STAs 2902 and 2903, to temporarily stop communication on a network. The AP 2901 performs scanning to determine whether or not radar wave is present in a channel currently used and other channels during the communication stop period. Also, the AP 2901 transmits an observation command frame to the STAs 2902 and 2903 to cause the STAs 2902 and 2903 to similarly perform scanning to determine whether or not radar wave is present in the channel currently used and other channels. After scanning for radar wave, the STAs 2902 and 2903 transmit an observation result reporting frame to the AP 2901. Thereafter, the AP 2901 determines a channel on which radar wave is present, based on the scan result by itself and the san result by the STAs 2902 and 2903. If radar wave is present on the currently used channel, the AP 2901 transmits a used channel shift command frame to the STAs 2902 and 2903, so that the channel is shifted to one in which radar wave is not present, avoiding interference between the communication wave of 802.11a and the radar wave.

Thus, various power line communication techniques have been developed, however, there is no unified standard for power line communication. However, all power lines in a home are connected to a distribution switchboard, and are also connected to an outdoor power line. Therefore, when power line communication modems of different schemes are used in the same home or in a home and near outside the home, the modems mutually receive communication signals. The power line communication modem of each scheme cannot demodulate signals of other schemes transmitted onto a communication channel by the power line communication modems of other schemes, i.e., for the power line communication modem of each scheme, signals of other schemes are merely noise. Therefore, when two different schemes coincidently perform communication, the schemes mutually interfere with communication, so that communication fails in both the schemes, communication speed is significantly reduced, or the like.

As a method for avoiding such a problem, it is considered that a unified standard for power line communication is newly established. However, the establishment of a new standard requires huge time and cost, and therefore, cannot be immediately realized. Alternatively, it is considered that a band or a communication time is uniquely assigned to each communication system, thereby avoiding interference. In the above-described 802.11a, since meteorological radars are the only significant noise source in the 5-GHz band used therein, it is possible to achieve DFS as in 802.11h only by providing to all terminals a simple carrier sense mechanism even for radio waves of different modulation schemes. However, in a short wave band used by a power line communication modem, attenuated modem signals of different modulation schemes and noise of electronic appliances have substantially the same signal level, so that it is not possible to determine the presence or absence of power line communication using a carrier sense mechanism, and therefore, a DFS mechanism as in 802.11h cannot be easily constructed.

### SUMMARY OF THE INVENTION

Therefore, an object of the present invention is to provide a transmission/reception apparatus and method for easily enabling coexistence of two communication systems which use the same communication medium and have different communication schemes.

The present invention is directed to a first communication system connected to a second communication system having a different communication scheme, via the same communication medium, using frequency division multiplexing or time division multiplexing, and a transmission/reception apparatus for a master station and a transmission/reception apparatus for a slave station belonging to the first communication system. To achieve the object, the transmission/reception apparatus for a master station comprises a detection section, a determination section, and an informing section, and the transmission/reception apparatus for a slave station comprises a reception section and a setting section.

In the transmission/reception apparatus for a master station, the detection section detects a frequency band or a time region used by the second communication system, or the presence or absence of the second communication system. The determination section determines a frequency band or a time region to be used in the first communication system, based on the frequency band or the time region or the presence or absence of the second communication system detected by the detection section. The informing section informs the transmission/reception apparatus for a slave station belonging to the first communication system of the frequency band or the time region determined by the determination section.

In this case, preferably, the informing section informs of the frequency band or the time region determined by the determination section using a control signal which is regularly transmitted in the first communication system and in which the frequency band is included, or using a frequency band or a time region minimally required for coexistence with the second communication system.

In the transmission/reception apparatus for a slave station, the reception section receives information about a frequency band or a time region to be used in the first communication system from the transmission/reception apparatus for a master station belonging to the first communication system. The setting section sets a frequency band or a time region to be used for data communication in accordance with the information about the frequency band or the time region received by the reception section.

Typically, the first and second communication systems are each a power line communication system, and the communication medium is a power line. In this case, for example, the first communication system is a power line communication system for in-home communication, and the second communication system is a power line communication system for access communication. Alternatively, the first and second communication systems are each a wireless communication system, and the communication medium is radio wave.

The processes performed by the parts of the above-described transmission/reception apparatuses may be considered as a transmission/reception method providing a series of processes. This method is provided in the form of a program for causing a computer to execute the series of processes. The program may be recorded on a computer-readable recording medium, which is introduced into a computer. The whole or a part of the functional blocks of the above-described transmission/reception apparatuses may be implemented as an integrated circuit (LSI)

According to the present invention, a master station belonging to a first communication system detects the presence or absence of a second communication system or a frequency band or a time region used by the second communication system, and informs a slave station belonging to the first communication system so that the slave station uses a frequency band or a time region which prevents the communication systems from interfering with each other. Thereby, it is possible to cause the two communication systems which utilize the same communication medium and have different communication schemes to coexist in an easy and inexpensive manner.

These and other objects, features, aspects and advantages of the present invention will become more apparent from the following detailed description of the present invention when taken in conjunction with the accompanying drawings.

### BRIEF DESCRIPTION OF THE DRAWINGS

FIG. 1 is a diagram schematically illustrating a communication system employing a transmission/reception apparatus according to first, third and fourth embodiments of the present invention;

FIG. 2 is a diagram illustrating an exemplary channel configuration of the communication system of the first embodiment;

FIG. 3 is a diagram schematically illustrating timing with which each station in the communication system of the first embodiment performs transmission/reception of a coexistence signal;

FIG. 4 is a diagram illustrating an exemplary configuration of an access-system master station and an access-system slave station of the first embodiment;

FIG. 5 is a diagram illustrating an exemplary configuration of an in-home-system master station of the first embodiment;

FIG. 6 is a diagram illustrating an exemplary configuration of an in-home-system slave station of the first embodiment;

FIG. 7 is a flowchart for explaining a process performed by an access-system master station or an access-system slave station;

FIG. 8 is a flowchart illustrating a process performed by the in-home-system master station of the first embodiment;

FIG. 9 is a flowchart illustrating a process performed by the in-home-system slave station of the first embodiment;

FIG. 10 is a diagram illustrating an exemplary configuration of a frame for informing of a frequency band to be used;

FIG. 11 is a diagram illustrating another exemplary configuration of a frame for informing of a frequency band to be used;

FIG. 12 is a diagram schematically illustrating a communication system employing a transmission/reception apparatus according to a second embodiment of the present invention;

FIG. 13 is a diagram illustrating an exemplary configuration of a master station A and a master station B of the second embodiment;

FIG. 14 is a diagram illustrating an exemplary configuration of a slave station A and a slave station B of the second embodiment;

FIG. 15 is a flowchart illustrating a process performed by the master station A and the master station B of the second embodiment;

FIG. 16 is a flowchart illustrating a process performed by the slave station A and the slave station B of the second embodiment;

FIG. 17 is a diagram illustrating an exemplary configuration of time slots used by a communication system of the third embodiment;

FIG. 18 is a diagram illustrating an exemplary configuration of channels used by a communication system of the third embodiment;

FIG. 19 is a diagram illustrating an exemplary configuration of channels used by a communication system of the fourth embodiment;

FIG. 20 is a diagram illustrating an exemplary configuration of an access-system master station and an access-system slave station of the fourth embodiment;

FIG. 21 is a diagram illustrating an exemplary configuration of an in-home-system master station of the fourth embodiment;

FIG. 22 is a diagram illustrating an exemplary configuration of an in-home-system slave station of the fourth embodiment;

FIG. 23 is a flowchart illustrating a process performed by the in-home-system master station of the fourth embodiment;

FIG. 24 is a sequence diagram for explaining transmission/reception of a coexistence signal performed by the power line communication system of the fourth embodiment;

FIG. 25 is a diagram illustrating an exemplary configuration of a conventional communication system which accesses the Internet;

FIG. 26 is a diagram illustrating an exemplary configuration of a conventional communication system employing a conversion adaptor;

FIG. 27 is a diagram illustrating an exemplary configuration of a conventional communication system employing a power line communication modem;

FIG. 28 is a diagram illustrating an exemplary internal configuration of a general power line communication modem; and

FIG. 29 is a diagram illustrating an exemplary configuration of a conventional communication system which performs a DFS operation.

### DESCRIPTION OF THE PREFERRED EMBODIMENTS

Hereinafter, embodiments of the present invention will be described with reference to the accompanying drawings. Note that the following embodiments will be described, assuming that a communication medium is a power line, though the communication medium may be a wireless, or a wired medium other than power lines.

### First Embodiment

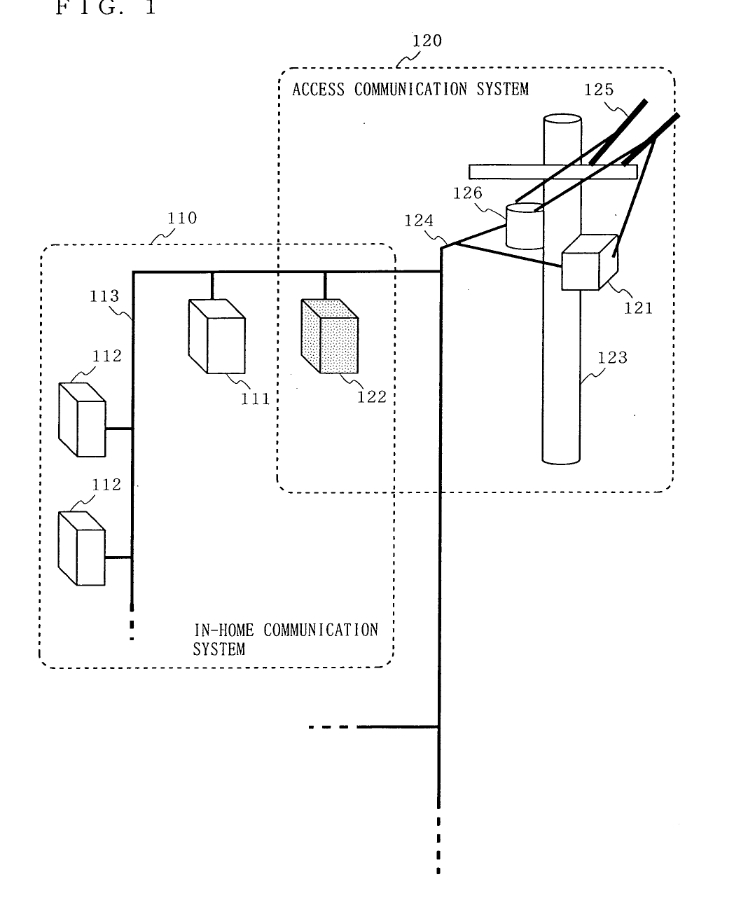

In a first embodiment, an example will be described in which two communication systems are caused to coexist using a Frequency Division Multiplexing (FDM) technique. FIG. 1 is a diagram schematically illustrating a communication system employing a transmission/reception apparatus according to the first embodiment of the present invention. In the first embodiment, as the two communication systems, an in-home communication system 110 and an access communication system 120 are defined.

The in-home communication system 110 is a power line communication system which utilizes a power line 113 provided in a home, and is composed of an in-home-system master station 111 which controls coexistence of the in-home communication system 110 and the access communication system 120, and an in-home-system slave station 112 other than the in-home-system master station 111. The in-home-system master station 111 is a transmission/reception apparatus which has a function of receiving a coexistence signal which is issued by a station belonging to the access communication system 120, and transferring the coexistence signal to the in-home-system slave station 112. In general, only one in-home-system master station 111 is provided in a home, and may be fixedly specified or may be dynamically determined or changed during operation. The in-home-system slave station 112 is a transmission/reception apparatus which is operated in a control of the in-home-system master station 111, and one or more in-home-system slave stations 112 are provided in one in-home communication system 110.

The access communication system 120 is a power line communication system which utilizes the in-home power line 113, a low voltage power distribution line 124 provided from the home to a pole transformer 126 provided on a utility pole 123, and an intermediate voltage power distribution line 125 from the pole transformer 126 to an electric power substation (not shown). Of transmission/reception apparatuses belonging to the access communication system 120, there are an access-system master station 121, and an access-system in-home apparatus (hereinafter referred to as an access-system slave station) 122 provided in the home, which are located within a range which causes interference with the in-home communication system 110. The access-system master station 121 may be provided as a transmission/reception apparatus separated from the pole transformer 126 as illustrated in FIG. 1, or may be incorporated in the pole transformer 126. Alternatively, in view of, for example, the case where a power line is buried under the earth, the access-system master station 121 may be incorporated in an appropriate apparatus other than the pole transformer 126.

Note that, for example, the access-system slave station 122 can also be provided on the low voltage power distribution line 124 outside the home, and a communication function of the in-home communication system 110 can be assigned to the access-system slave station 122. Although not illustrated in FIG. 1, the in-home-system master station 111 and the access-system slave station 122 are connected to each other via Ethernet, wireless LAN, or the like in the in-home communication system 110 and the access communication system 120, or alternatively, for example, the in-home-system master station 111 and the access-system slave station 122 are provided in a single apparatus, thereby making it possible to achieve intercommunication.

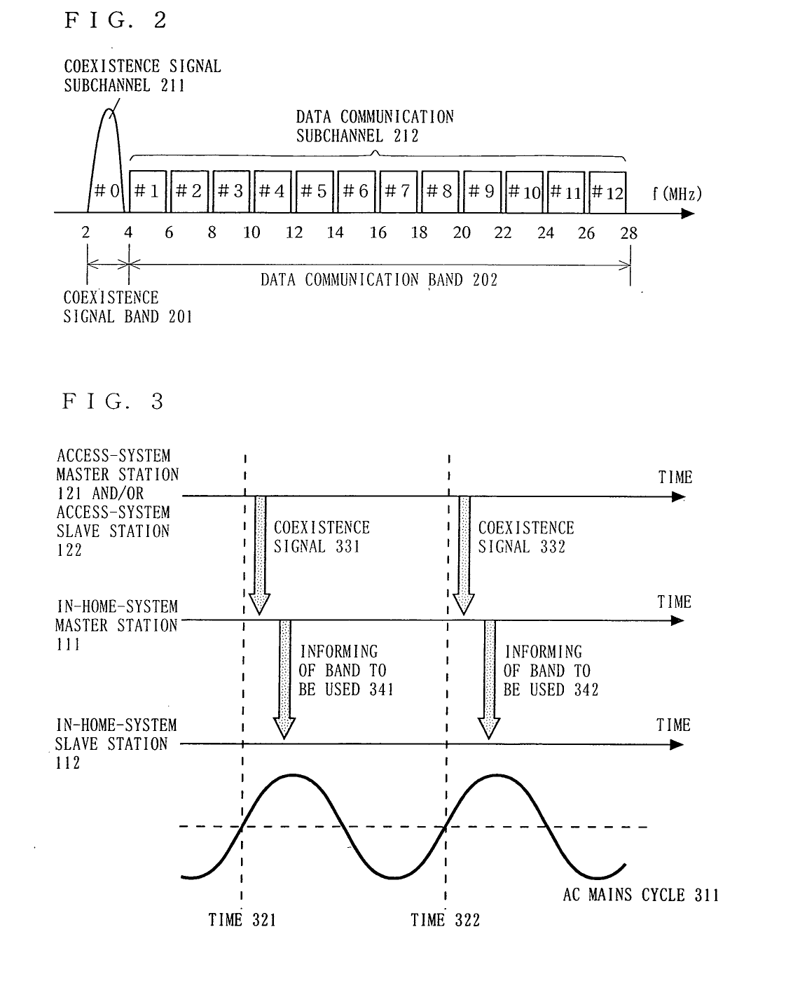

In the first embodiment, the in-home communication system 110 and the access communication system 120 are assumed to have a function capable of using a frequency band of 2 MHz to 28 MHz. FIG. 2 illustrates an exemplary channel configuration of a power line communication system which is utilized by the in-home communication system 110 and the access communication system 120. In the example of FIG. 2, the frequency band is divided into 13 subchannels #0 to #12. #0 indicates a coexistence signal subchannel 211 which has a frequency band of 2 MHz to 4 MHz and is used for transmission/reception of a coexistence signal for causing the in-home communication system 110 and the access communication system 120 to coexist without interfering with each other's communication. #1 to #12 indicate a data communication subchannel 212 which has frequency bands obtained by dividing 4 MHz to 28 MHz into intervals of 2 MHz, and is used for data communication in the in-home communication system 110 and the access communication system 120.

In the first embodiment, the in-home communication system 110 uses the coexistence signal subchannel 211 to detect a frequency band which is used by the access communication system 120, and the in-home communication system 110 and the access communication system 120 share and utilize the data communication subchannel 212, thereby achieving coexistence using frequency division multiplexing. Hereinafter, system coexistence by frequency division multiplexing will be specifically described. Note that a band used by the coexistence signal subchannel 211 is defined as a coexistence signal band 201, and a band used by the data communication subchannel 212 is defined as a data communication band 202.

Initially, transmission/reception of a coexistence signal which is performed by the in-home communication system 110 and the access communication system 120, will be described.

FIG. 3 is a diagram schematically illustrating timing with which each station in the in-home communication system 110 and the access communication system 120 performs transmission/reception of a coexistence signal. The access-system master station 121 and/or the access-system slave station 122 transmit coexistence signals 331 and 332 including information about a subchannel used by the access communication system 120, onto a power line, using a zero-crossing point (a point having a phase of 0 degrees) of an alternating current flowing through the power line as a reference (times 321 and 322). Note that the coexistence signals 331 and 332 may be transmitted using a time point having a phase of the alternating current deviated from the zero-crossing point by a predetermined amount, as a reference, instead of the zero-crossing point. Also, the coexistence signal does not need to be transmitted at all zero-crossing points or all time points deviated by the predetermined phase. The in-home-system master station 111 receives the coexistence signals 331 and 332 to determine a subchannel which should be used by itself. Also, the in-home-system master station 111 informs the in-home-system slave station 112 in the in-home communication system 110 of information about a subchannel used by the in-home communication system 110, using a function of the in-home communication system 110, i.e., band-to-be-used informing signals 341 and 342 in FIG. 3.

Next, a detailed configuration and process operation of each station in the in-home communication system 110 and the access communication system 120 will be described.

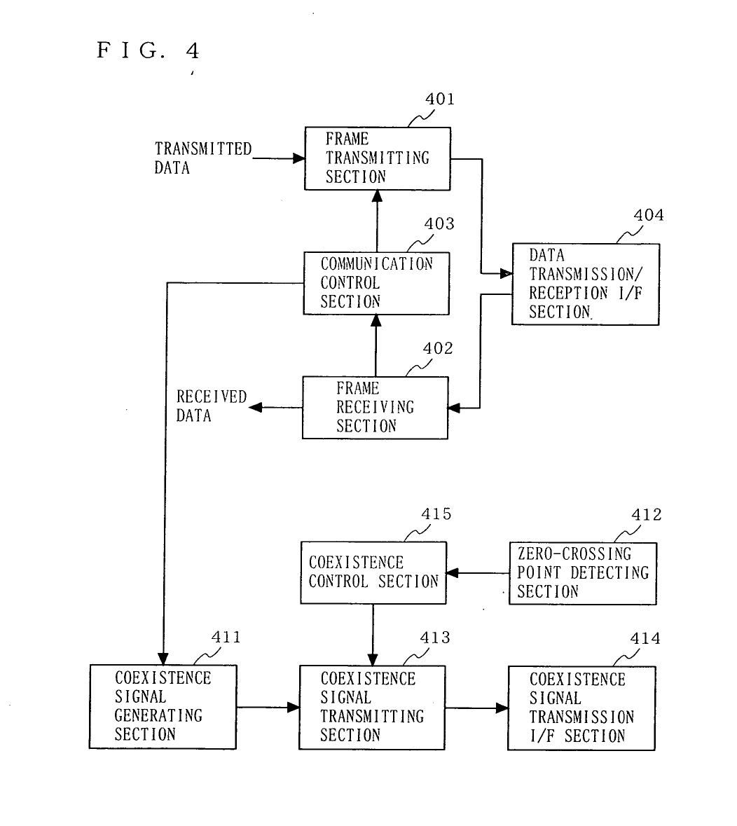

FIG. 4 illustrates an exemplary configuration of a station having a function of transmitting a signal for coexistence with the in-home communication system 110 (hereinafter referred to as a coexistence signal transmitting station), of the access-system master station 121 and the access-system slave station 122. The coexistence signal transmitting station of FIG. 4 is roughly divided into parts 401 to 404 used for data communication in the access communication system 120, and parts 411 to 415 used for transmission of a coexistence signal. FIG. 7 is a flowchart for explaining only a process relating to coexistence of the communication systems of processes performed by the coexistence signal transmitting station.

A frame receiving section 402 receives a transmitted frame via a data transmission/reception I/F section 404, and subjects the frame into a required process to generate received data. A frame transmitting section 401 frames data to be transmitted in the access communication system 120, and transfers the data to the data transmission/reception I/F section 404, thereby performing data transmission. In this case, a communication control section 403 which controls data transmission/reception while referencing information from the frame receiving section 402, controls timing of data transmission of the frame transmitting section 401.

A coexistence signal generating section 411 receives information about a subchannel (frequency band) used by the access communication system 120 from the communication control section 403, and based on this, generates a coexistence signal (the signals 331 and 332 in FIG. 3) including the information about the subchannel used by the access communication system 120, and transfers the coexistence signal to a coexistence signal transmitting section 413. A zero-crossing point detecting section 412 detects a zero-crossing point of an alternating current flowing through a power distribution line, and informs a coexistence control section 415 of the detection result (step S702). The coexistence control section 415 instructs timing of transmission of the coexistence signal to the coexistence signal transmitting section 413 in accordance with the information from the zero-crossing point detecting section 412. The coexistence signal transmitting section 413 transmits the coexistence signal via a coexistence signal transmission I/F section 414 based on the timing instructed by the coexistence control section 415 (step S703). Thereafter, the processes of step S702 and step S703 are repeatedly performed.

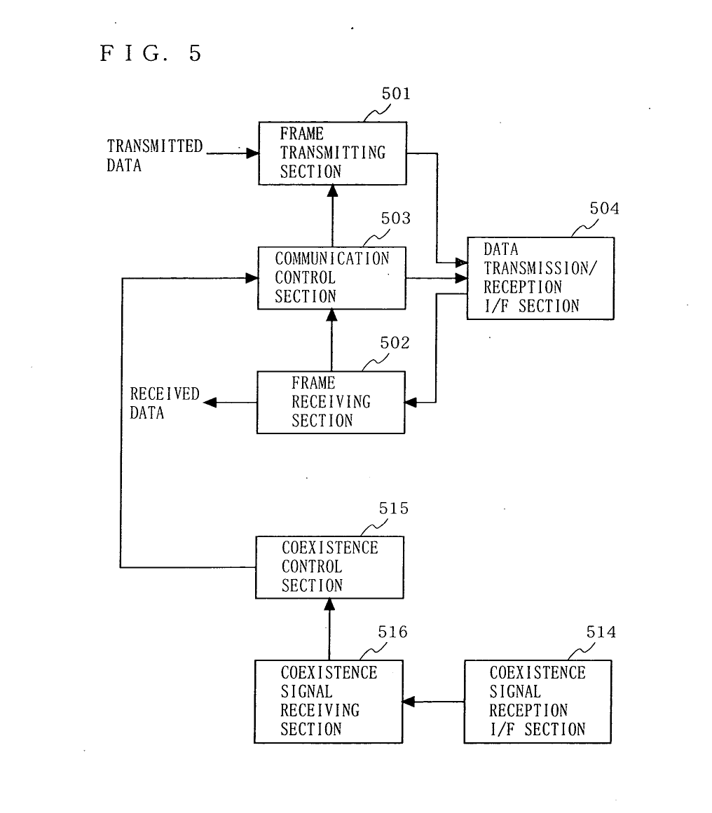

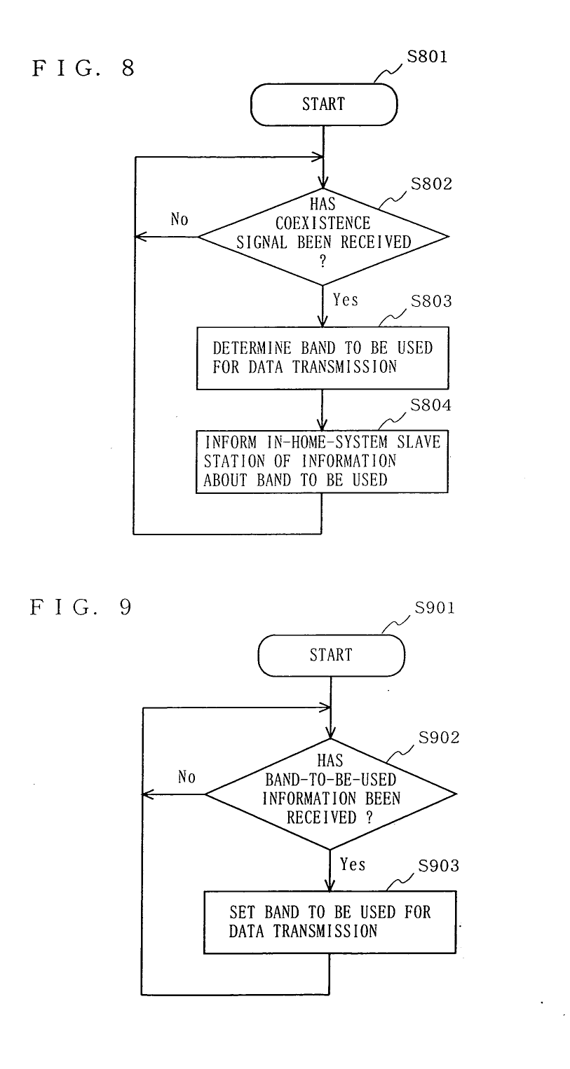

FIG. 5 illustrates an exemplary configuration of the in-home-system master station 111. The in-home-system master station 111 of FIG. 5 is roughly divided into parts 501 to 504 used for data communication performed in the in-home communication system 110, and parts 514 to 516 used for reception of a coexistence signal transmitted by a coexistence signal transmitting station belonging to the access communication system 120. Also, the parts 514 and 516, the parts 503 and 515, and the parts 501 and 504 are categorized into a detection section, a determination section, and an informing section, respectively, in terms of function. FIG. 8 is a flowchart for explaining only a process relating to coexistence of the communication systems of processes performed by the in-home-system master station 111.

A frame receiving section 502 receives a transmitted frame via a data transmission/reception I/F section 504, and subjects the frame into a required process to generate received data. A frame transmitting section 501 frames data to be transmitted in the in-home communication system 110, and transfers the data to the data transmission/reception I/F section 504, thereby performing data transmission. In this case, a communication control section 503 which controls data transmission/reception while referencing information from the frame receiving section 502, controls timing of data transmission of the frame transmitting section 501.

A coexistence signal receiving section 516 checks whether or not a coexistence signal has been received via a coexistence signal reception I/F section 514 (step S802). When a coexistence signal has been received, the coexistence signal receiving section 516 analyzes the coexistence signal to obtain information about a subchannel used by the access communication system 120, and informs the coexistence control section 515 of the information. Based on this information, the coexistence control section 515 determines a subchannel which should be used by the in-home communication system 110 (step S803), and informs the communication control section 503 of the subchannel. The communication control section 503 instructs the informed subchannel to the data transmission/reception I/F section 504. The data transmission/reception I/F section 504 performs frame transmission/reception using the instructed subchannel. Also, the communication control section 503 generates a frame including information about a frequency band to be used in the in-home communication system 110 (the information 341 and 342 in FIG. 3), and transfers the frame to the frame transmitting section 501. The frame transmitting section 501 transmits the frame including the information about the subchannel, via the data transmission/reception I/F section 504, to the in-home-system slave station 112 (step S804). Thereafter, the processes of steps S802 to S804 are repeatedly performed. Note that the frame including the information about a frequency band to be used in the in-home communication system 110 may be transmitted using a subchannel which is already used before reception of a coexistence signal from the access communication system 120, instead of using a new subchannel instructed by the data transmission/reception I/F section 504 as described above.

Note that information about a subchannel (frequency band) to be used may be informed of using a dedicated frame. Alternatively, in a communication system in which a master station regularly transmits a special control frame, the information about a subchannel to be used may be stored in the special control frame. For example, the dedicated frame is a frame for an access control function of CSMA/CA or the like, and the special control frame is a frame for polling or beaconing.

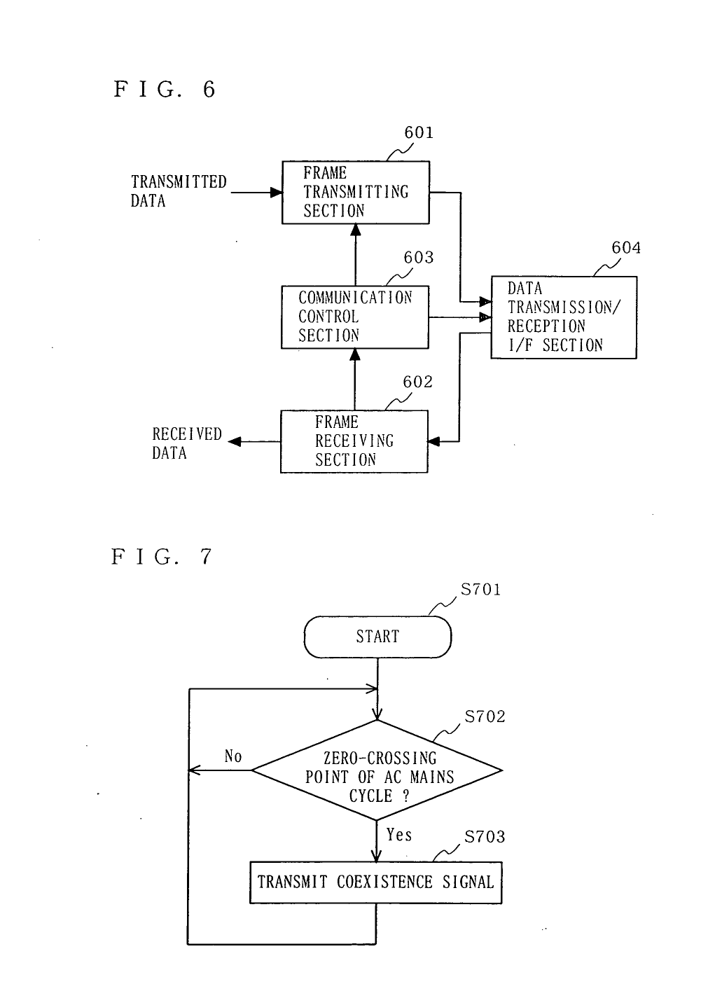

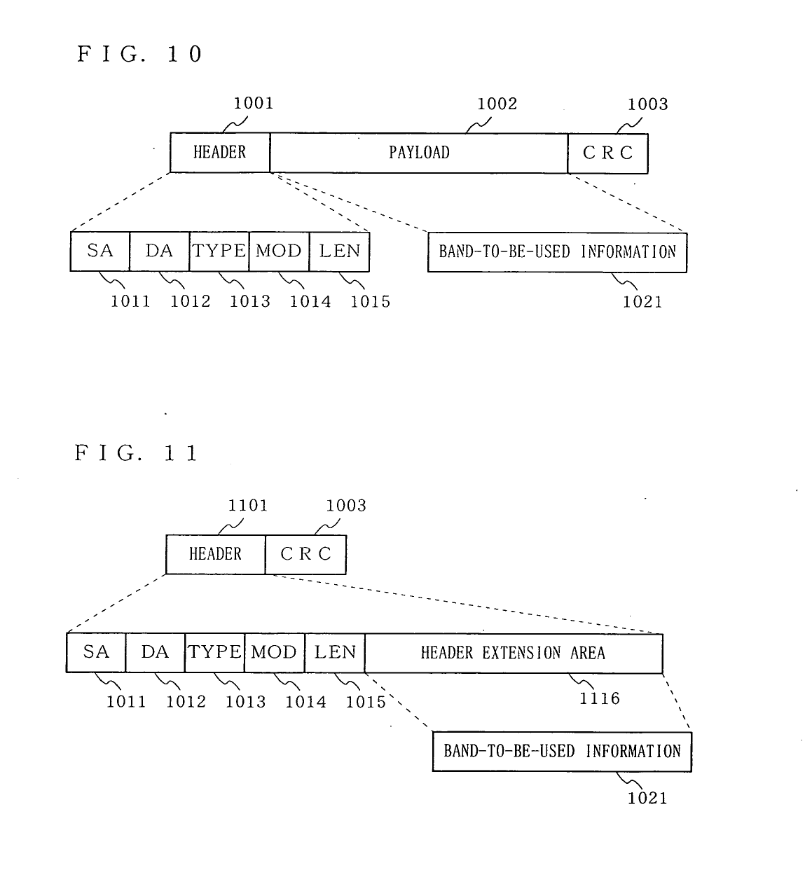

FIG. 6 illustrates an exemplary configuration of the in-home-system slave station 112. The in-home-system slave station 112 of FIG. 6 does not have a configuration for a coexistence signal, and therefore, is composed only of parts 601 to 604 used for data communication performed in the in-home communication system 110. The parts 602 and 604 and the part 603 are categorized into a reception section and a setting section, respectively, in terms of function. FIG. 9 is a flowchart for explaining a process performed by the in-home-system slave station 112.

A frame receiving section 602 receives a transmitted frame via a data transmission/reception I/F section 604, and subjects the data to a required process to generate received data. A frame transmitting section 601 frames data to be transmitted in the in-home communication system 110, and transfers the data to the data transmission/reception I/F section 604, thereby performing data transmission. In this case, a communication control section 603 which controls data transmission/reception while referencing information from the frame receiving section 602, controls timing of data transmission of the frame transmitting section 601. Also, the frame receiving section 602 checks whether or not a frame including information about a subchannel to be used in the in-home communication system 110 (the information 341 and 342 in FIG. 3) has been received (step S902) . When the frame has been received, the frame receiving section 602 transfers the information to the communication control section 603. The communication control section 603 instructs the information to the data transmission/reception I/F section 604. Based on the instructed information, the data transmission/reception I/F section 604 sets a subchannel to be used for frame transmission/reception (step S903). Thereafter, the processes of steps S902 and S903 are repeatedly performed.

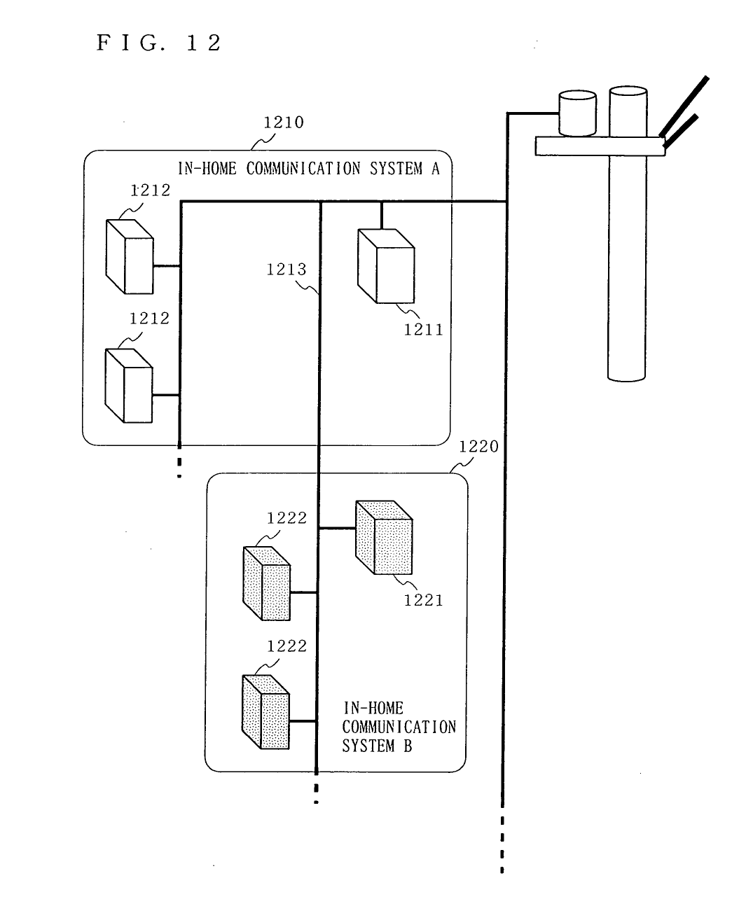

Next, a frame for informing of information about a frequency band to be used, which is transmitted from the in-home-system master station 111 to the in-home-system slave station 112, will be described. FIGS. 10 and 11 are diagrams illustrating frames for informing of the information about a frequency band to be used.

The frame of FIG. 10 is composed of a header 1001, a payload 1002, and a CRC 1003. The header 1001 is a block for storing a frame attribute and control information, and is typically modulated using a specific modulation technique highly resistant to error. The header 1001 is composed of a Source Address (SA) field 1011 for identifying a transmission station in the in-home communication system 110, a Destination Address (DA) field 1012 for identifying a reception station in the in-home communication system 110, a TYPE field 1013 for storing a frame type, a MOD field 1014 for identifying a modulation technique used for the payload 1002, and an LEN field 1015 for specifying a size of the payload 1002. Although not illustrated in FIG. 10, the header 1001 may have, for example, a field for storing a frame attribute or control information, in addition to those described above.

The payload 1002 is a field for storing data transferred from an upper layer protocol, or protocol control information. In this frame, band-to-be-used information 1021 which is information about a frequency band to be used is stored in the payload 1002. The band-to-be-used information 1021 is generally considered to be specified by a subchannel number illustrated in FIG. 2, or a lower limit value and an upper limit value of the frequency band to be used, or may be specified by other methods.

The CRC 1003 is a Cyclic Redundancy Code (CRC) for detecting an error in the payload 1002 occurring in a reception station. By using this error detection code, a transmission channel error can be detected up to a predetermined amount. By adding an error correction code (Reed-Solomon code, etc.) in addition to the error detection code, it is possible to provide a capability to correct a transmission channel error up to a predetermined amount.

On the other hand, as illustrated in FIG. 11, the band-to-be-used information 1021 may be stored in a-header, but not in a payload. In the case of this configuration, there is no data which should be stored in a payload, so that the frame is composed only of a header 1101 and a CRC 1003. The header 1101 is composed of an SA field 1011, a DA field 1012, a TYPE field 1013, a MOD field 1014, an LEN field 1015, and a header extension area 1116. Since there is no payload in this frame, this is informed of by using a method of setting the LEN field 1015 to have a value of “0”, for example. The band to be used information 1021 is stored in the header extension area 1116.

### Second Embodiment

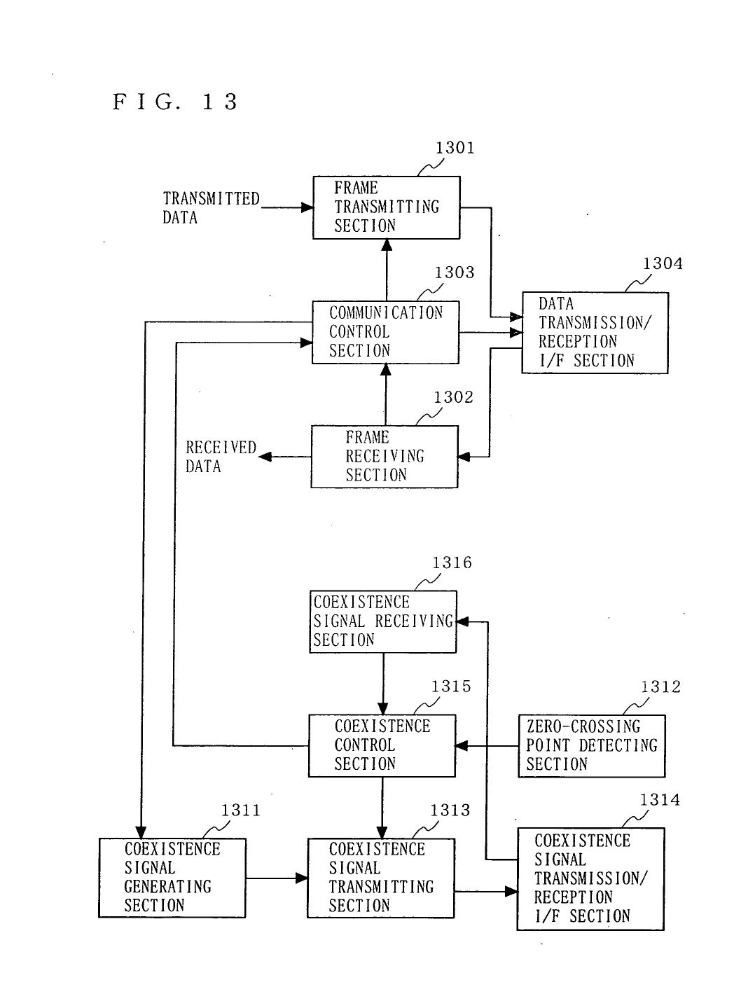

In a second embodiment, another example will be described in which two communication systems are caused to coexist using a frequency division multiplexing technique similar to that of the first embodiment. FIG. 12 is a diagram schematically illustrating a configuration of a communication system employing a transmission/reception apparatus according to a second embodiment of the present invention. In the second embodiment, as the two communication systems, a communication system A1210 and a communication system B1220 which are both present in an in-home system, are defined.

The communication system A1210 is a power line communication system which utilizes a power line 1213 provided in a home, and is composed of a master station A1211 which controls coexistence with the communication system B1220, and a slave station A1212 other than the master station A1211. The master station A1211 is a transmission/reception apparatus which has a function of receiving a coexistence signal which is issued by a master station belonging to the communication system B1220, and transferring the coexistence signal to the slave station A1212. The communication system B1220 is also a power line communication system which utilizes the power line 1213, and is composed of a master station B1221 which controls coexistence with the communication system A1210, and a slave station B1222 other than the master station B1221. The master station B1221 is a transmission/reception apparatus which has a function of receiving a coexistence signal which is issued by a master station belonging to the communication system A1210, and transferring the coexistence signal to the slave station B1222. In general, only one master station is present in each communication system, and may be either fixedly specified or dynamically determined or changed during operation. A slave station is a transmission/reception apparatus which is operated in a control of a master station. One or more slave stations are present in each communication system.

In the second embodiment, any one of the communication system A1210 and the communication system B1220 detects a frequency band used by the other communication system using the coexistence signal subchannel 211, and the two communication systems share and utilize the data communication subchannel 212, thereby achieving coexistence using frequency division multiplexing (see FIG. 2). Hereinafter, the system coexistence by frequency division multiplexing will be specifically described.

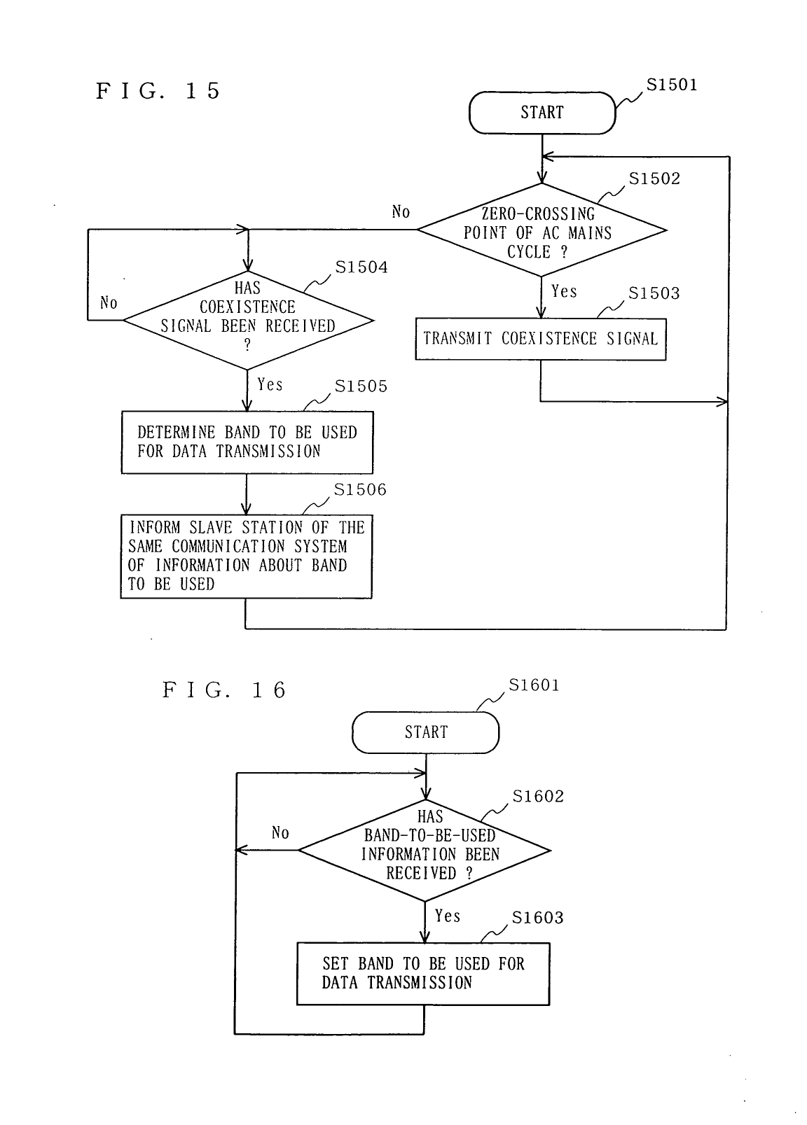

FIG. 13 illustrates an exemplary configuration of the master station A1211 and the master station B1221. The master station A1211 and the master station B1221 of FIG. 13 are roughly divided into parts 1301 to 1304 used for data communication performed in a communication system to which the master station A1211 or the master station B1221 belong, and parts 1311 to 1316 used for reception of a coexistence signal transmitted by a master station of the other communication system. Also, the parts 1314 and 1316, the parts 1303 and 1315, and the parts 1301 and 1304 are categorized into a detection section and an informing section, respectively, in terms of function. FIG. 15 is a flowchart for explaining only a process relating to coexistence of the communication systems of processes performed by the master station A1211 or the master station B1221.

A frame receiving section 1302 receives a transmitted frame via a data transmission/reception I/F section 1304, and subjects the frame to a required process to generate received data. A frame transmitting section 1301 frames data to be transmitted in the communication system to which the master station A1211 or the master station B1221 belong, and transfers the data to the data transmission/reception I/F section 1304, thereby performing data transmission. In this case, a communication control section 1303 which controls data transmission/reception while referencing information from the frame receiving section 1302, controls timing of data transmission of the frame transmitting section 1301.

When a coexistence signal is transmitted, a coexistence signal generating section 1311 receives information about a subchannel used by the communication system to which the master station A1211 or the master station B1221 belong, from the communication control section 1303, and based on this, generates a coexistence signal including information about a subchannel to be used by the other communication system, and transfers the coexistence signal to a coexistence signal transmitting section 1313. A zero-crossing point detecting section 1312 detects a zero-crossing point of an alternating current flowing through a power distribution line, and informs a coexistence control section 1315 of the detection result (step S1502). The coexistence control section 1315 instructs timing of transmission of the coexistence signal to the coexistence signal transmitting section 1313 in accordance with the information from the zero-crossing point detecting section 1312. The coexistence signal transmitting section 1313 transmits the coexistence signal via a coexistence signal transmission/reception I/F section 1314 in accordance with the timing instructed by the coexistence control section 1315 (step S1503).

When a coexistence signal is received, a coexistence signal receiving section 1316 checks whether or not the coexistence signal has been received via the coexistence signal transmission/reception I/F section 1314 (step S1504). When the coexistence signal has been received, the coexistence signal receiving section 1316 analyzes the coexistence signal to obtain information about a subchannel used by the other communication system, and informs the coexistence control section 1315 of the information. Based on the information, the coexistence control section 1315 determines a subchannel which should be used by the communication system to which the master station A1211 or the master station B1221 belong (step S1505), and informs the communication control section 1303 of the subchannel. The communication control section 1303 instructs the informed subchannel to the data transmission/reception I/F section 1304. The data transmission/reception I/F section 1304 performs frame transmission/reception using the instructed subchannel. Also, the communication control section 1303 generates a frame including information about a frequency band to be used by the communication system to which the master station A1211 or the master station B1221 belong, and transfers the frame to the frame transmitting section 1301. The frame transmitting section 1301 transmits a frame including information about the subchannel via the data transmission/reception I/F section 1304 to a slave station of the communication system to which the master station A1211 or the master station B1221 belong (step S1506). Thereafter, the processes of steps S1502 to S1506 are repeatedly performed. Note that the frame including the information about the frequency band to be used in the communication system to which the master station A1211 or the master station B1221 belong, may be transmitted using a subchannel which is already used before reception of a coexistence signal from the other communication system, instead of using a new subchannel instructed by the data transmission/reception I/F section 1304 as described above.

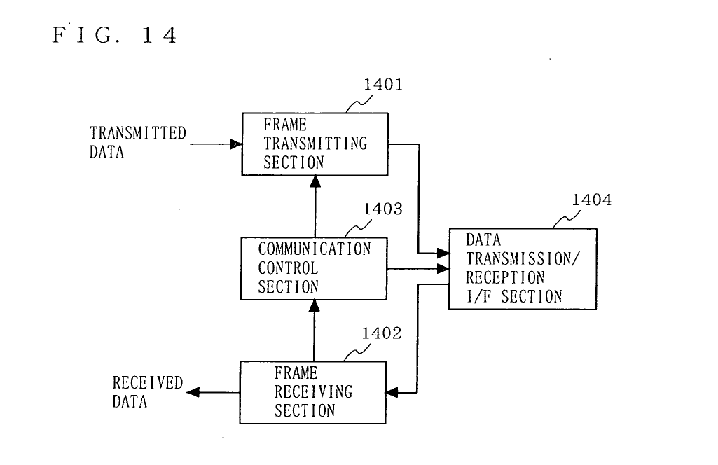

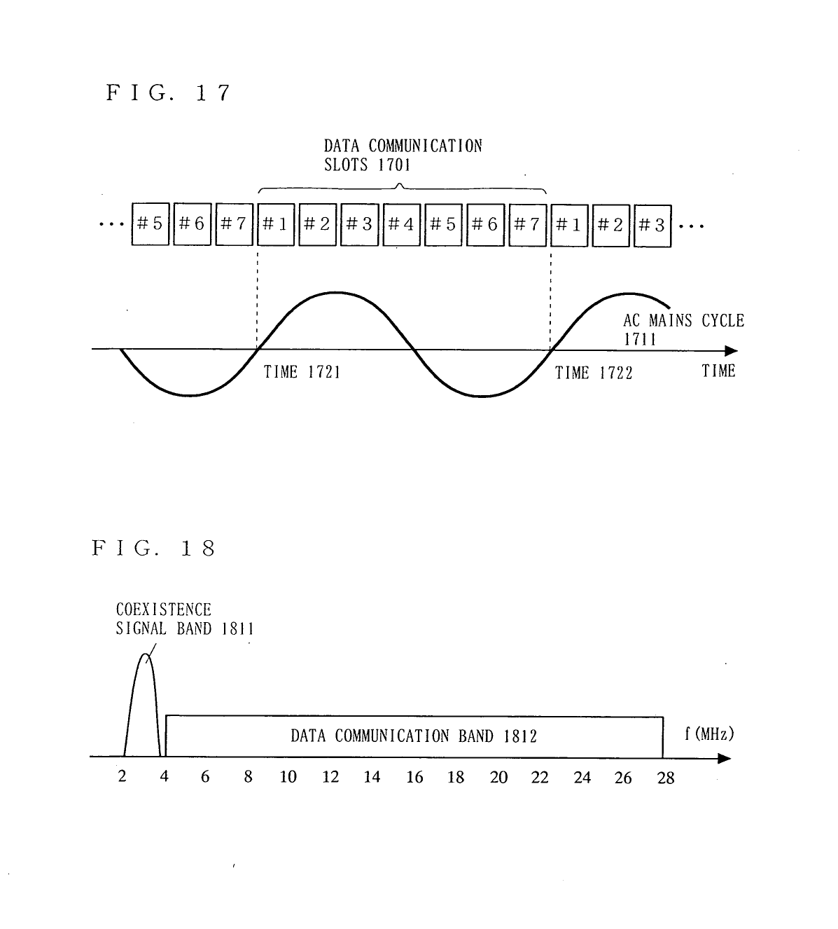

FIG. 14 illustrates an exemplary configuration of the slave station A1212 and the slave station B1222. The slave station A1212 and the slave station B1222 of FIG. 14 does not have a configuration for a coexistence signal, and therefore, is composed only of parts 1401 to 1404 used for data communication performed in a communication system to which the slave station A1212 or the slave station B1222 belong. Also, the parts 1402 and 1404 and the part 1403 are categorized into a reception section and a setting section, respectively, in terms of function. FIG. 16 is a flowchart for explaining a process performed by the slave station A1212 or the slave station B1222.

A frame receiving section 1402 receives a transmitted frame via a data transmission/reception I/F section 1404, and subjects the data to a required process to generate received data. A frame transmitting section 1401 frames data to be transmitted in the communication system to which the slave station A1212 or the slave station B1222 belong, and transfers the data to the data transmission/reception I/F section 1404, thereby performing data transmission. In this case, a communication control section 1403 which controls data transmission/reception while referencing information from the frame receiving section 1402, controls timing of data transmission of the frame transmitting section 1401. Also, the frame receiving section 1402 checks whether or not a frame including information about a frequency band to be used in the communication system to which the slave station A1212 or the slave station B1222 belong has been received (step S1602). When the frame has been received, the frame receiving section 1402 transfers the information to the communication control section 1403. The communication control section 1403 instructs the information to the data transmission/reception I/F section 1404. Based on the instructed information, the data transmission/reception I/F section 1404 sets a subchannel to be used for frame transmission/reception (step S1603). Thereafter, the processes of steps S1602 and S1603 are repeatedly performed.

### Third Embodiment

In a third embodiment, an example will be described in which two communication systems are caused to coexist using a Time Division Multiplexing (TDM) technique. A communication system employing a transmission/reception apparatus according to the third embodiment of the present invention has a rough configuration in which two communication systems, i.e., an in-home communication system 110 and an access communication system 120, are provided as in the first embodiment of FIG. 1. Also, a master station and a slave station included in each communication system have the same detailed configuration and operation as those illustrated in FIGS. 4 to 9. The third embodiment is different from the first embodiment in that information transmitted from the access communication system 120 to the in-home communication system 110 is information about a slot to be used, but not information about a band to be used. Hereinafter, the difference will be described.

FIG. 17 is a diagram illustrating an example of division of time slots by TDM which are used by the in-home communication system 110 and the access communication system 120. In the example of FIG. 17, each AC mains cycle (one cycle from time 1721 to time 1722) is divided into seven time slots #1 to #7 using a zero-crossing point of an AC mains frequency as a reference.

An example of use of the frequency in this case is illustrated in FIG. 18. Both the in-home communication system 110 and the access communication system 120 use a coexistence signal band 1811 of 2 MHz to 4 MHz and a data communication band 1812 of 4 MHz to 28 MHz. The coexistence signal band 1811 is used to determine which of the time slots #1 to #7 of FIG. 17 is to be used by the in-home communication system 110 and the access communication system 120. The data communication band 1812 is a frequency band which is used for data communication in the in-home communication system 110 and the access communication system 120, and is used by the time slots #1 to #7 of FIG. 17.

In the coexistence signal transmitting station (see FIG. 4), the coexistence signal generating section 411 receives information about a time slot used by the access communication system 120 from the communication control section 403, and based on this, generates a coexistence signal including the information about the time slot used by the access communication system 120, and transfers the coexistence signal to the coexistence signal transmitting section 413. The coexistence signal transmitting section 413 transmits the coexistence signal via the coexistence signal transmission I/F section 414 based on timing instructed by the coexistence control section 415. The information about the time slot is included in a portion of the band-to-be-used information 1021 of FIG. 10 or 11, and is transmitted toward the in-home-system master station 111.

In the in-home-system master station 111 (see FIG. 5), the coexistence signal receiving section 516 analyzes the received coexistence signal to obtain the information about the time slot used by the access communication system 120, and informs the coexistence control section 515 of the information. Based on the information, the coexistence control section 515 determines a time slot which should be used by the in-home communication system 110, and informs the communication control section 503 of the time slot. The communication control section 503 controls timing of transmission of a frame so that the time slot informed by the coexistence control section 515 is used. Also, the communication control section 503 generates a frame including information about the time slot to be used by the in-home communication system 110 and transfers the frame to the frame transmitting section 501.

In the in-home-system slave station 112 (see FIG. 6), the frame receiving section 602 checks whether or not the frame including the information about the time slot to be used by the in-home communication system 110 has been received. When the frame has been received, the frame receiving section 602 transfers the information to the communication control section 603. Based on the transferred information, the communication control section 603 determines a time slot which should be used for frame transmission/reception.

### Fourth Embodiment

In a fourth embodiment, an example will be described in which two communication systems are caused to coexist using a frequency division multiplexing technique different from those of the first and second embodiments. A communication system employing a transmission/reception apparatus according to the fourth embodiment of the present invention has a rough configuration in which two communication systems, i.e., an in-home communication system 110 and an access communication system 120, are provided as in the first embodiment of FIG. 1. The fourth embodiment is different from the first embodiment in the configurations of a coexistence signal transmitting station and an in-home-system master station. Hereinafter, the difference will be described.

In the fourth embodiment, the in-home communication system 110 and the access communication system 120 are assumed to have a function capable of using a frequency band of 4 MHz to 28 MHz. FIG. 19 illustrates an exemplary configuration of a channel in a power line communication system which is utilized by the in-home communication system 110 and the access communication system 120. In the example of FIG. 19, a data communication frequency band 1901 is divided into two subchannels #1 and #2. #1 is an access-system priority subchannel 1911 which has a frequency band of 4 MHz to 16 MHz. The access-system priority subchannel 1911 is a band in which priority is given to use by the access communication system 120, and the in-home communication system 110 cannot use when the presence of the access communication system 120 is detected. #2 is an in-home-system-specific subchannel 1912 which has a frequency band of 16 MHz to 28 MHz. The in-home-system-specific subchannel 1912 is a dedicated band which can be used only by the in-home communication system 110, and cannot be used by the access communication system 120. Note that the band division method of FIG. 19 is only for illustrative purposes, and the band can be divided in an arbitrary manner as long as the manner is previously defined both in the in-home communication system 110 and the access communication system 120.

Next, a detailed configuration and process operation of each station of the in-home communication system 110 and the access communication system 120 will be described.

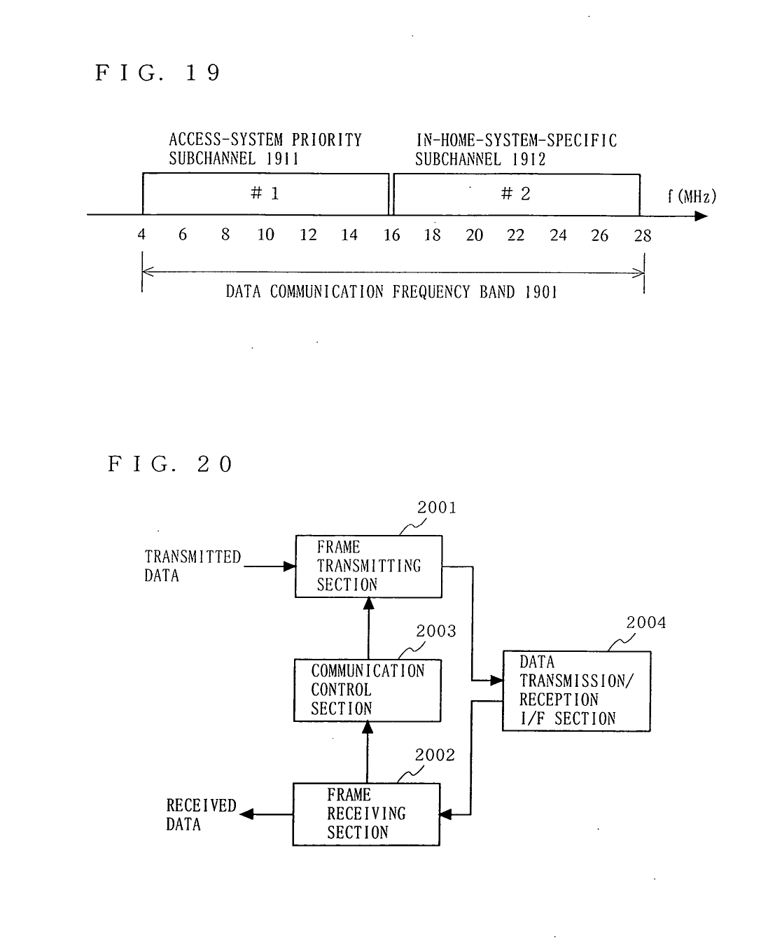

FIG. 20 illustrates an exemplary configuration of the access-system master station 121 and the access-system slave station 122. The communication system of the fourth embodiment is different from that of the first embodiment in that transmission/reception of a coexistence signal is not explicitly performed between the in-home communication system 110 and the access communication system 120. Therefore, a master station and a slave station belonging to the access communication system 120 are composed only of parts 2001 to 2004 used for data communication performed in the access communication system 120.

A frame receiving section 2002 receives a transmitted frame via a data transmission/reception I/F section 2004, and subjects the frame to a required process to generate received data. A frame transmitting section 2001 frames data to be transmitted in the access communication system 120, and transfers the data to the data transmission/reception I/F section 2004, thereby performing data transmission. In this case, a communication control section 2003 which controls data transmission/reception while referencing information from the frame receiving section 2002, controls timing of data transmission of the frame transmitting section 2001.

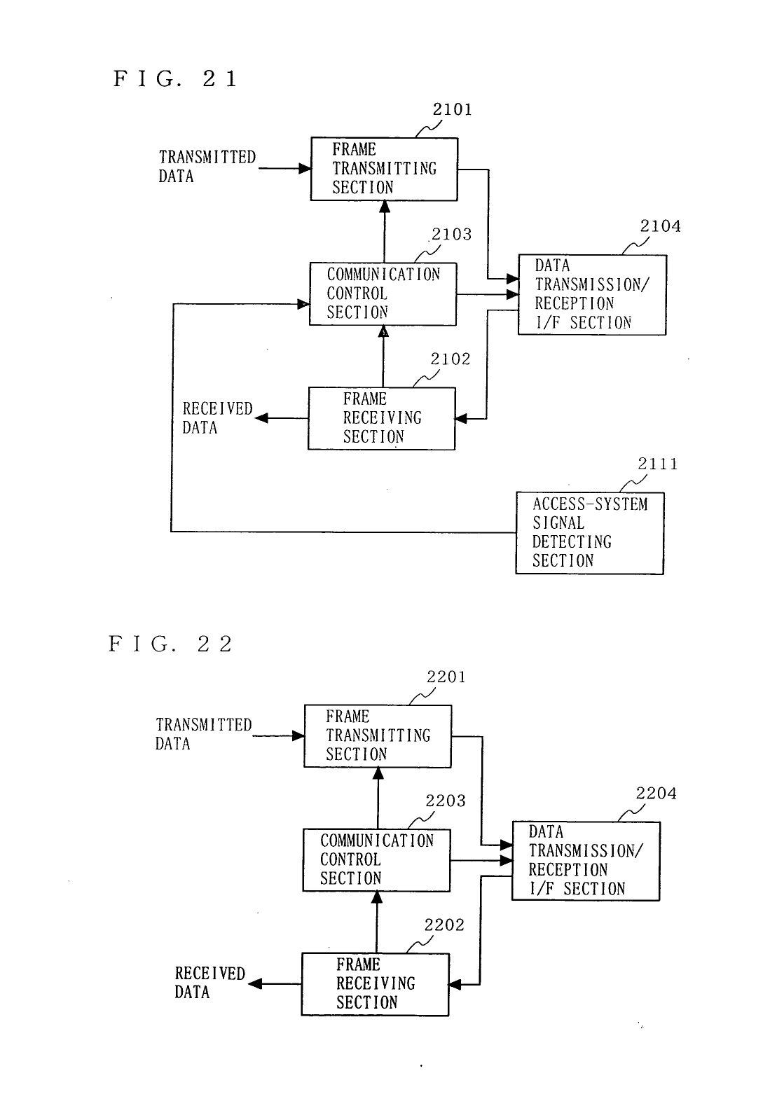

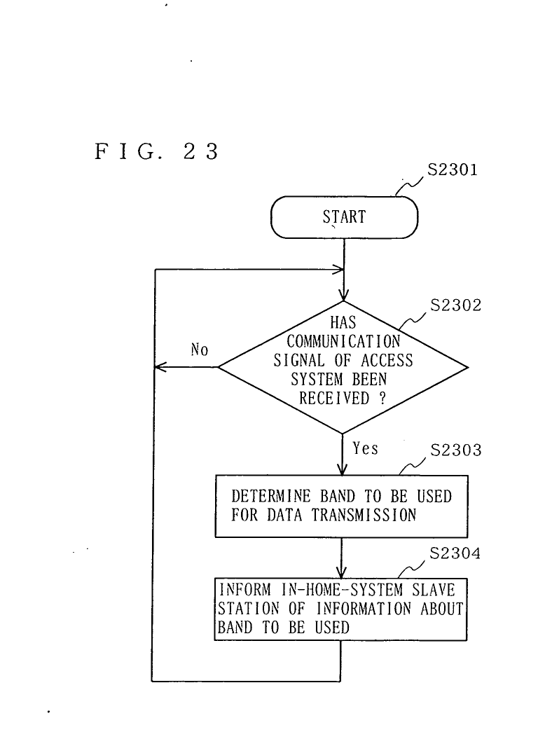

FIG. 21 is an exemplary configuration of the in-home-system master station 111. The in-home-system master station 111 of FIG. 21 is roughly divided into parts 2101 to 2104 used for data communication performed in the in-home communication system 110, and a part 2111 for detection of communication of a master station or a slave station belonging to the access communication system 120. Also, the part 2111, the part 2103, and the parts 2101 and 2104 are categorized into a detection section, a determination section, and an informing section, respectively, in terms of function. FIG. 23 is a flowchart for explaining only a process relating to coexistence of the communication systems of processes performed by the in-home-system master station 111.

A frame receiving section 2102 receives a transmitted frame via a data transmission/reception I/F section 2104, and subjects the frame to a required process to generate received data. A frame transmitting section 2101 frames data to be transmitted in the in-home communication system 110, and transfers the data to the data transmission/reception I/F section 2104, thereby performing data transmission. In this case, a communication control section 2103 which controls data transmission/reception while referencing information from the frame receiving section 2102, controls timing of data transmission of the frame transmitting section 2101.

An access-system signal detection section 2111 checks whether or not a communication signal of the access-system master station 121 or the access-system slave station 122 has been detected (step S2302). When the communication signal of the access-system master station 121 and the access-system slave station 122 has been detected, the access-system signal detection section 2111 informs the communication control section 2103 of the detection result. The communication control section 2103 determines that a subchannel used for communication is limited to #2 (step S2303), and instructs the subchannel #2 to the data transmission/reception I/F section 2104. The data transmission/reception I/F section 2104 uses the instructed subchannel to perform frame transmission/reception. Also, the communication control section 2103 creates a frame for informing the in-home-system slave station 112 of the limitation on use of the subchannel, and transfers the frame to the frame transmitting section 2101. The frame transmitting section 2101 transmits a frame including information about the subchannel via the data transmission/reception I/F section 2104 to the in-home-system slave station 112 (step S2304). Thereafter, the processes of steps S2302 to S2304 are repeatedly performed. Note that the frame including the information about the subchannel is transmitted from the in-home-system master station 111 to the in-home-system slave station 112 using both the subchannel #1 and the subchannel #2, instead of using only the subchannel #2 as described above.

Note that, if a mechanical switch or the like is used so that the user can explicitly set the presence or absence of the access communication system 120, the configuration of the in-home-system master station 111 to the access-system signal detection section 2111 can be removed.

FIG. 22 is an exemplary configuration of the in-home-system slave station 112. The in-home-system slave station 112 of FIG. 22 does not have a configuration relating to a coexistence signal, and therefore, is composed only of parts 2201 to 2204 which are used for data communication in the in-home communication system 110. Also, the parts 2202 and 2204 and the part 2203 are categorized into a reception section and a setting section, respectively, in terms of function.

A frame receiving section 2202 receives a transmitted frame via a data transmission/reception I/F section 2204, and subjects the frame to a required process to generate received data. A frame transmitting section 2201 frames data to be transmitted in the in-home communication system 110, and transfers the data to the data transmission/reception I/F section 2204, thereby performing data transmission. In this case, a communication control section 2203 which controls data transmission/reception while referencing information from the frame receiving section 2202, controls timing of data transmission of the frame transmitting section 2201. Also, the frame receiving section 2202 checks whether or not a frame including information about a frequency band to be used in the in-home communication system 110 has been received. When the frame has been received, the frame receiving section 2202 transfers the information to the communication control section 2203. The communication control section 2203 instructs the information to the data transmission/reception I/F section 2204. Based on the instructed information, the data transmission/reception I/F section 2204 limits and determines a frequency band which should be used for frame transmission/reception, only to the in-home-system-specific subchannel #2.

Note that the configuration of a frame for informing of information about a frequency band to be used, which is transmitted from the in-home-system master station 111 to the in-home-system slave station 112, may be basically similar to that of FIG. 10 or 11. However, in the example of the fourth embodiment, since only either the subchannels #1 and #2 or the subchannel #2 is used as the frequency band to be used, the following simplification can be achieved. For example, one-bit information is given as the band-to-be-used information 1021, and it is defined that if the bit is “1”, the frequency band to be used is limited only to the subchannel #2. Alternatively, a special value is assigned to the TYPE field 1013, and it is defined that if the special value is included in the TYPE field 1013, the frequency band to be used is limited only to the subchannel #2. In this case, the portion of the band-to-be-used information 1021 can be removed from a frame.

As described above, according to the transmission/reception apparatus and the transmission/reception method according to the first to fourth embodiments of the present invention, a master station of an in-home communication system detects the presence of another communication system, or a frequency band or a time region used by another communication system, and informs a slave station of the in-home communication system of the frequency band or the time region so that a frequency band or a time region which avoids communication interference between the two communication systems can be used. Thereby, it is possible to cause two communication systems which utilize the same communication medium and have different communication schemes, to coexist in an easy and inexpensive manner.

Note that the method for coexistence of communication systems by time division multiplexing which is described in the third embodiment can be applied to coexistence of in-home communication systems described in the second embodiment. Also, the method described in the fourth embodiment in which transmission/reception of a coexistence signal is not explicitly performed, can be applied to any of the first to third embodiments.

The first to fourth embodiments have been described, assuming that, in the in-home communication systems 110, 1210 and 1220, only the in-home-system master stations 111, 1211 and 1221 can detect a coexistence signal or a communication signal which is transmitted from the other communication system. However, a portion or all of the in-home-system slave stations 112, 1212 and 1222 in the in-home communication systems 110, 1210 and 1220 may have a function capable of detecting a coexistence signal or a communication signal.

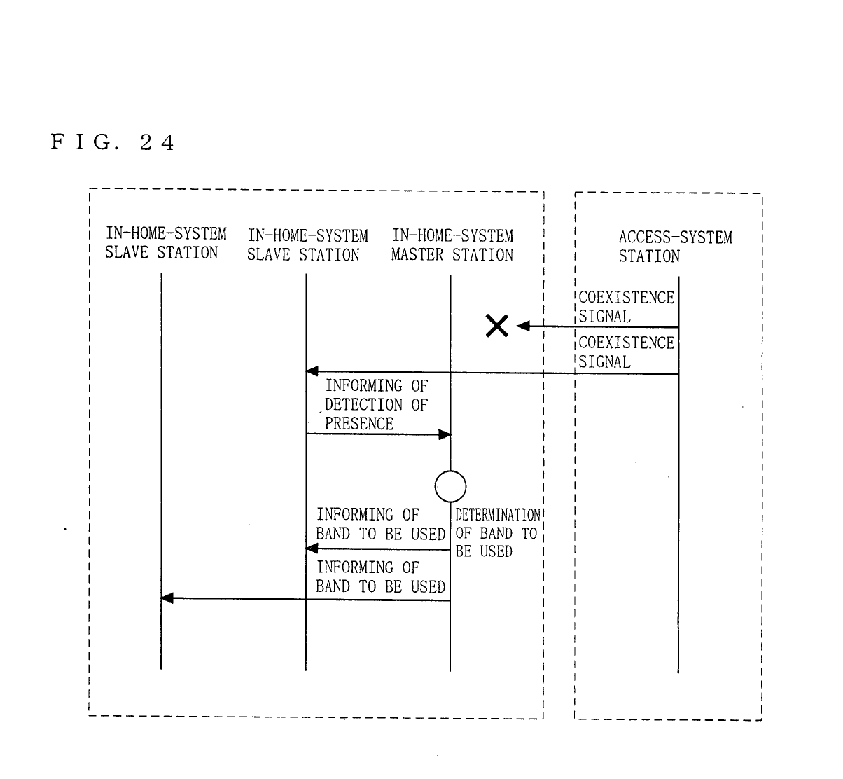

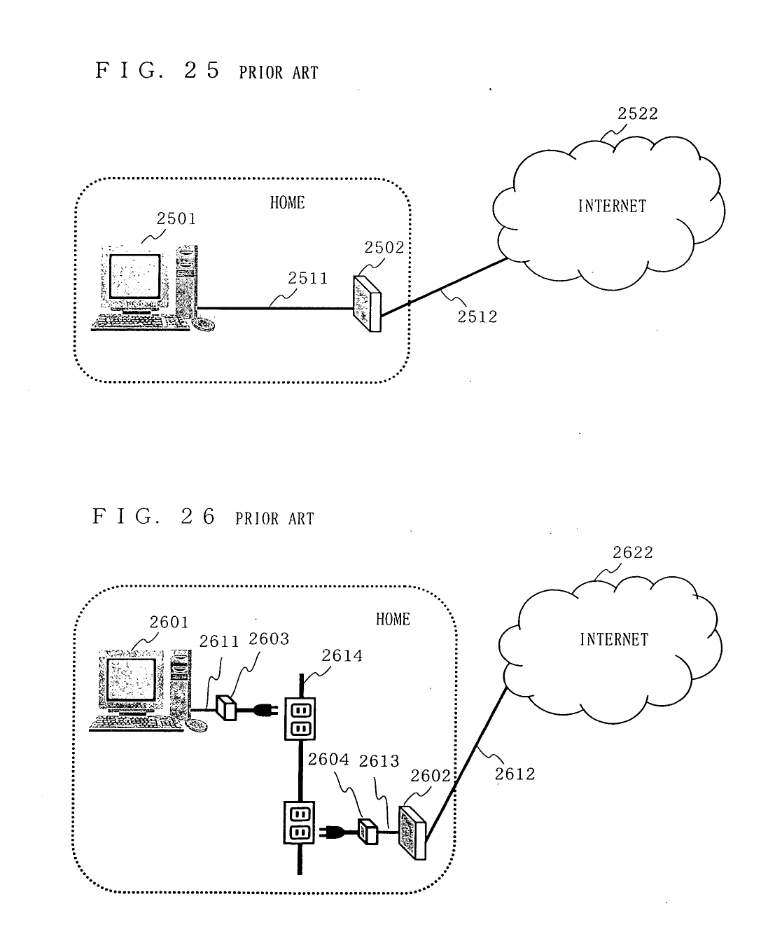

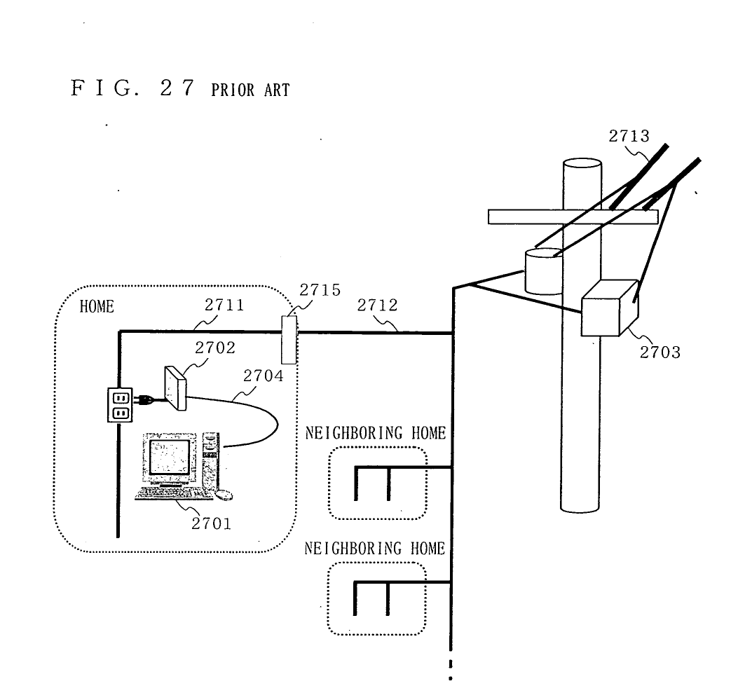

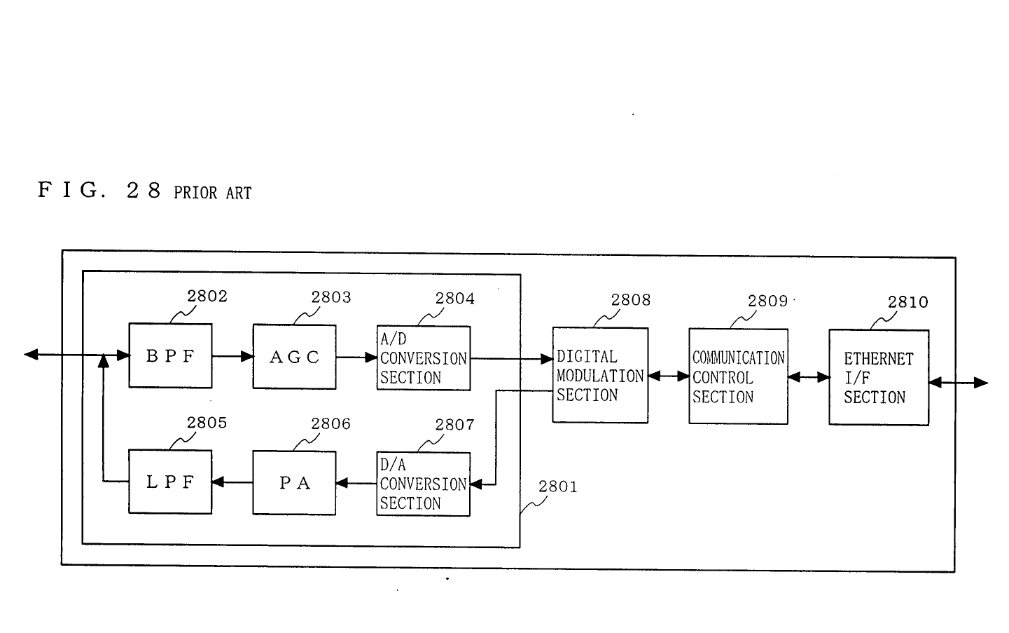

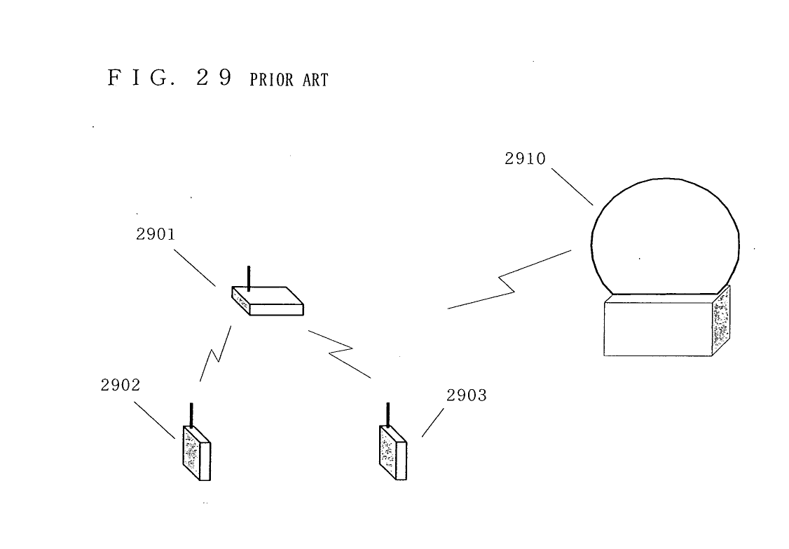

In this case, preferably, the in-home-system slave stations 112, 1212 and 1222 which detect a coexistence signal or a communication signal, inform the in-home-system master stations 111, 1211 and 1221 of information about a used frequency or a used time, and after a frequency band or a time which should be used is determined in the in-home-system master stations 111, 1211 and 1221, the in-home-system slave stations 112, 1212 and 1222 are informed again of the contents of the determination (see FIG. 24). In this case, when an in-home-system master station informs in-home-system slave stations of a frequency band, each in-home-system slave station may be informed of separately or by multicast. If an in-home-system master station and each in-home-system slave station share an algorithm for determining a frequency band or a time which should be used by themselves, based on reception of a coexistence signal or a communication signal, the in-home-system master station does not need to inform an in-home-system slave station which detects a coexistence signal or a communication signal, of a frequency band or a time which should be used.

Also, the first to fourth embodiments have been described, assuming that information transmitted from the in-home-system master stations 111, 1211 and 1221 to the in-home-system slave stations 112, 1212 and 1222 is a frequency band or a time to be used in the in-home communication systems 110, 1210 and 1220. However, the transmitted information may be a frequency band or a time used in the other communication system which are detected using a coexistence signal.

Also, the first to fourth embodiments have been described, assuming that a communication system is a power line communication system. However, the communication systems 110 and 120, and the communication systems 1210 and 1220 may be both wireless communication systems. In this case, if each station in a wireless communication system is connected to a commercialized AC mains, it is possible to achieve synchronization with a zero-crossing point of the commercialized AC mains as a reference, as is similar to the case of power line communication systems. In this case, the zero-crossing point detecting section (reference numeral 412 in FIG. 4 and reference numeral 1312 in FIG. 13) in the exemplary configuration of each apparatus is a portion for detecting a zero-crossing point of the commercialized AC mains, and the other portions of FIGS. 4 to 6, 13, 14 and 20 to 22 are portions for wireless communication.

Note that the above-described embodiments may be each implemented by causing a CPU to interpret and execute predetermined program data capable of executing the above-described procedure, the program being stored in a storage apparatus (a ROM, a RAM, a hard disk, etc.). In this case, the program data may be stored into the storage apparatus via a recording medium, or may be executed directly from the recording medium. The recording medium refers to a semiconductor memory, such as a ROM, a RAM, a flash memory or the like; a magnetic disk memory, such as a flexible disk, a hard disk or the like; an optical disc, such as a CD-ROM, a DVD, a BD or the like; a memory card; or the like. The recording medium is a concept including a communication medium, such as a telephone line, a transfer line, or the like.

Functional blocks of each embodiment, such as the frame transmitting section, the frame receiving section, the communication control section, the coexistence signal transmitting section, the coexistence signal receiving section, the coexistence control section, the coexistence signal generating section, and the like, may be typically implemented as an integrated circuit (LSI: LSI is be called IC, system LSI, super LSI or ultra LSI, depending on the packaging density). Each functional block may be separately mounted on one chip, or a part or the whole of the functional blocks may be mounted on one chip. Also, a portion involved in communication and a portion involved in transmission/reception of a coexistence signal in one communication system may be mounted on separate LSI chips.

The integrated circuit is not limited to LSI. The integrated circuit may be achieved by a dedicated circuit or a general-purpose processor. Further, an Field Programmable Gate Array (FPGA) which can be programmed after LSI production or a reconfigurable processor in which connection or settings of circuit cells in LSI can be reconfigured, may be used.

Furthermore, if an integrated circuit technology which replaces LSI is developed by an advance in the semiconductor technology or the advent of other technologies derived therefrom, the functional blocks may be packaged using such a technology. A biotechnology may be applicable.

The in-home communication apparatus of the present invention may be in the form of an adaptor which converts a signal interface, such as Ethernet interface, IEEE1394 interface, USB interface, or the like, into interface for power line communication, and thereby, can be connected to multimedia apparatuses, such as a personal computer, a DVD recorder, a digital television, a home system server, and the like, which have various kinds of interface. Thereby, a network system which transmits digital data, such as multimedia data or the like, via a power line as a medium with high speed, can be constructed. As a result, a power line which is already provided in homes, offices and the like can be directly used as a network line without newly introducing a network cable, such as a conventional wired LAN. Therefore, the present invention is considerably useful in terms of cost and ease of installation.

The functions of the present invention may be incorporated into the above-described multimedia apparatuses in the future. Thereby, data transfer can be achieved between the multimedia apparatuses via a power source cable thereof. In this case, an adaptor, an Ethernet cable, an IEEE1394 cable, a USB cable, and the like are not required, thereby simplifying wiring. Also, the high-speed power line transmission system of the present invention can be connected via a rooter to the Internet, or via a hub to a wireless LAN or a conventional wired cable LAN, thereby extending a LAN system in which the high-speed power line transmission system of the present invention is used without any problem. Communication data transferred via a power line by power line transmission may be intercepted by an apparatus directly connected to the power line, but is free from an eavesdrop problem with wireless LAN. Therefore, the power line transmission scheme is effective for data protection in terms of security. Further, data transferred on a power line may be protected by IPSec of an IP protocol, encryption of the contents themselves, other DRM schemes, or the like.

As compared to conventional power line communication, high-quality AV content transmission on a power line can be achieved by using a copyright protection function employing the above-described encryption of contents or efficient communication media (an effect of the present invention), and further implementing a QoS function.

While the invention has been described in detail, the foregoing description is in all aspects illustrative and not restrictive. It is understood that numerous other modifications and variations can be devised without departing from the scope of the invention.

What is claimed is:

1. A transmission/reception apparatus for a master station belonging to a first communication system connected to a second communication system having a different communication scheme, via the same communication medium, using frequency division multiplexing, the apparatus comprising:
a detection section for detecting a frequency band used by the second communication system;
a determination section for determining a frequency band to be used in the first communication system, based on the frequency band detected by the detection section; and
an informing section for informing a transmission/reception apparatus for a slave station belonging to the first communication system of the frequency band determined by the determination section.

2. A transmission/reception apparatus for a master station belonging to a first communication system connected to a second communication system having a different communication scheme, via the same communication medium, using frequency division multiplexing, the apparatus comprising:
a detection section for detecting the presence or absence of the second communication system;
a determination section for determining a frequency band to be used in the first communication system, based on the presence or absence detected by the detection section; and
an informing section for informing a transmission/reception apparatus for a slave station belonging to the first communication system of the frequency band determined by the determination section.

3. A transmission/reception apparatus for a master station belonging to a first communication system connected to a second communication system having a different communication scheme, via the same communication medium, using time division multiplexing, the apparatus comprising:
a detection section for detecting a time region used by the second communication system;
a determination section for determining a time region to be used in the first communication system, based on the time region detected by the detection section; and
an informing section for informing a transmission/reception apparatus for a slave station belonging to the first communication system of the time region determined by the determination section.

4. A transmission/reception apparatus for a master station belonging to a first communication system connected to a second communication system having a different communication scheme, via the same communication medium, using time division multiplexing, the apparatus comprising:
a detection section for detecting the presence or absence of the second communication system;
a determination section for determining a time region to be used in the first communication system, based on the presence or absence detected by the detection section; and
an informing section for informing a transmission/reception apparatus for a slave station belonging to the first communication system of the time region determined by the determination section.

5. The transmission/reception apparatus according to claim 1, wherein
the informing section informs of the frequency band determined by the determination section using a control signal which is regularly transmitted in the first communication system and in which the frequency band is included.

6. The transmission/reception apparatus according to claim 2, wherein
the informing section informs of the frequency band determined by the determination section using a control signal which is regularly transmitted in the first communication system and in which the frequency band is included.

7. The transmission/reception apparatus according to claim 3, wherein
the informing section informs of the time region determined by the determination section using a control signal which is regularly transmitted in the first communication system and in which the time region is included.

8. The transmission/reception apparatus according to claim 4, wherein
the informing section informs of the time region determined by the determination section using a control signal which is regularly transmitted in the first communication system and in which the time region is included.

9. The transmission/reception apparatus according to claim 1, wherein
the first and second communication systems are each a power line communication system, and the communication medium is a power line.

10. The transmission/reception apparatus according to claim 9, wherein
the first communication system is a power line communication system for in-home communication, and the second communication system is a power line communication system for access communication.

11. The transmission/reception apparatus according to claim 1, wherein
the first and second communication systems are each a wireless communication system, and the communication medium is radio wave.

12. A transmission/reception apparatus for a slave station belonging to a first communication system connected to a second communication system having a different communication scheme, via the same communication medium, using frequency division multiplexing, the apparatus comprising:
a reception section for receiving information about a frequency band to be used in the first communication system from a transmission/reception apparatus for a master station belonging to the first communication system; and
a setting section for setting a frequency band to be used for data communication in accordance with the information about the frequency band received by the reception section.

13. A transmission/reception apparatus for a slave station belonging to a first communication system connected to a second communication system having a different communication scheme, via the same communication medium, using time division multiplexing, the apparatus comprising:
a reception section for receiving information about a time region to be used in the first communication system from a transmission/reception apparatus for a master station belonging to the first communication system; and
a setting section for setting a time region to be used for data communication in accordance with the information about the time region received by the reception section.

14. The transmission/reception apparatus according to claim 12, wherein
the first and second communication systems are each a power line communication system, and the communication medium is a power line.

15. The transmission/reception apparatus according to claim 13, wherein
the first and second communication systems are each a power line communication system, and the communication medium is a power line.

16. The transmission/reception apparatus according to claim 14, wherein
the first communication system is a power line communication system for in-home communication, and the second communication system is a power line communication system for access communication.

17. The transmission/reception apparatus according to claim 15, wherein
the first communication system is a power line communication system for in-home communication, and the second communication system is a power line communication system for access communication.

18. The transmission/reception apparatus according to claim 12, wherein
the first and second communication systems are each a wireless communication system, and the communication medium is radio wave.

19. The transmission/reception apparatus according to claim 13, wherein
the first and second communication systems are each a wireless communication system, and the communication medium is radio wave.

20. A first communication system connected to a second communication system having a different communication scheme, via the same communication medium, using frequency division multiplexing, the first communication system including:
a transmission/reception apparatus for a master station comprising:
a detection section for detecting a frequency band used by the second communication system;
a determination section for determining a frequency band to be used in the first communication system, based on the frequency band detected by the detection section; and
an informing section for informing a transmission/reception apparatus for a slave station belonging to the first communication system of the frequency band determined by the determination section, and
the transmission/reception apparatus for a slave station comprising:
a reception section for receiving information about the frequency band to be used in the first communication system from the transmission/reception apparatus for a master station; and
a setting section for setting a frequency band to be used for data communication in accordance with the information about the frequency band received by the reception section.

21. A first communication system connected to a second communication system having a different communication scheme, via the same communication medium, using frequency division multiplexing, the first communication system including:
a transmission/reception apparatus for a master station comprising:
a detection section for detecting the presence or absence of the second communication system;
a determination section for determining a frequency band to be used in the first communication system, based on the presence or absence detected by the detection section; and
an informing section for informing a transmission/reception apparatus for a slave station belonging to the first communication system of the frequency band determined by the determination section, and
the transmission/reception apparatus for a slave station comprising:
a reception section for receiving information about the frequency band to be used in the first communication system from the transmission/reception apparatus for a master station; and
a setting section for setting a frequency band to be used for data communication in accordance with the information about the frequency band received by the reception section.

22. A first communication system connected to a second communication system having a different communication scheme, via the same communication medium, using time division multiplexing, the first communication system including:
a transmission/reception apparatus for a master station comprising:
a detection section for detecting a time region used by the second communication system;
a determination section for determining a time region to be used in the first communication system, based on the time region detected by the detection section; and
an informing section for informing a transmission/reception apparatus for a slave station belonging to the first communication system of the time region determined by the determination section, and
the transmission/reception apparatus for a slave station comprising:
a reception section for receiving information about the time region to be used in the first communication system from the transmission/reception apparatus for a master station; and
a setting section for setting a time region to be used for data communication in accordance with the information about the time region received by the reception section.

23. A first communication system connected to a second communication system having a different communication scheme, via the same communication medium, using time division multiplexing, the first communication system including:
a transmission/reception apparatus for a master station comprising:
a detection section for detecting the presence or absence of the second communication system;
a determination section for determining a time region to be used in the first communication system, based on the presence or absence detected by the detection section; and
an informing section for informing a transmission/reception apparatus for a slave station belonging to the first communication system of the time region determined by the determination section, and
the transmission/reception apparatus for a slave station comprising:
a reception section for receiving information about the time region to be used in the first communication system from the transmission/reception apparatus for a master station; and
a setting section for setting a time region to be used for data communication in accordance with the information about the time region received by the reception section.

24. A transmission/reception method performed in a first communication system connected to a second communication system having a different communication scheme, via the same communication medium, using frequency division multiplexing, wherein
a transmission/reception apparatus for a master station executes the steps of:
detecting a frequency band used by the second communication system;
determining a frequency band to be used in the first communication system, based on the detected frequency band; and
informing a transmission/reception apparatus for a slave station belonging to the first communication system of the determined frequency band, and
the transmission/reception apparatus for a slave station executing the steps of:
receiving information about the frequency band to be used in the first communication system from the transmission/reception apparatus for a master station; and
setting a frequency band to be used for data communication in accordance with the received information about the frequency band.

25. A transmission/reception method performed in a first communication system connected to a second communication system having a different communication scheme, via the same communication medium, using frequency division multiplexing, wherein
a transmission/reception apparatus for a master station executes the steps of:
detecting the presence or absence of the second communication system;
determining a frequency band to be used in the first communication system, based on the detected presence or absence; and
informing a transmission/reception apparatus for a slave station belonging to the first communication system of the determined frequency band, and
the transmission/reception apparatus for a slave station executing the steps of:
receiving information about the frequency band to be used in the first communication system from the transmission/reception apparatus for a master station; and
setting a frequency band to be used for data communication in accordance with the received information about the frequency band.

26. A transmission/reception method performed in a first communication system connected to a second communication system having a different communication scheme, via the same communication medium, using time division multiplexing, wherein
a transmission/reception apparatus for a master station executes the steps of:
detecting a time region used by the second communication system;
determining a time region to be used in the first communication system, based on the detected time region; and
informing a transmission/reception apparatus for a slave station belonging to the first communication system of the determined time region, and
the transmission/reception apparatus for a slave station executing the steps of:
receiving information about the time region to be used in the first communication system from the transmission/reception apparatus for a master station; and
setting a time region to be used for data communication in accordance with the received information about the time region.

27. A transmission/reception method performed in a first communication system connected to a second communication system having a different communication scheme, via the same communication medium, using time division multiplexing, wherein
a transmission/reception apparatus for a master station executes the steps of:
detecting the presence or absence of the second communication system;
determining a time region to be used in the first communication system, based on the detected presence or absence; and
informing a transmission/reception apparatus for a slave station belonging to the first communication system of the determined time region, and
the transmission/reception apparatus for a slave station executing the steps of:
receiving information about the time region to be used in the first communication system from the transmission/reception apparatus for a master station; and
setting a time region to be used for data communication in accordance with the received information about the time region.
